(19) United States
(12) Patent Application Publication
(10) Pub. No.: US 2026/0170015 A1
(43) Pub. Date: Jun. 18, 2026

(54) GENERATIVE AI INSIGHT ARCHIVES

(71) Applicant: Microsoft Technology Licensing, LLC, Redmond, WA (US)

(72) Inventor: Worachart CHANTAKRAIWAT, Round Rock, TX (US)

(73) Assignee: Microsoft Technology Licensing, LLC, Redmond, WA (US)

(21) Appl. No.: 18/980,491

(22) Filed: Dec. 13, 2024

(51) Int. Cl. G06F 16/28; G06F 16/25

(52) U.S. Cl. CPC G06F 16/285; G06F 16/258

(57) ABSTRACT

The present disclosure relates to generative AI insight archives. A generative AI system may generate and use insight archives to determine new insights, e.g., during generative AI model sessions. The new insights may be interpolated based on information obtained from existing insight archives and new information may be extracted from generative AI model sessions based on the new insights and the prompts and corresponding responses of the session. The new insights and corresponding information may be stored in existing and new insight archives. Existing insight archives may be based on previous generative AI model sessions, encapsulating documents, data, and insights associated with those sessions. Subsequent generative AI model sessions may leverage information stored within the insight archives through processes like data extraction, interpolation, and conversion to alternative formats such as presentation slides, reports, or summaries. Insight archives may be merged to consolidate related insights.

### BACKGROUND

In today's data-driven world, the ability to swiftly access, understand, and act upon insights is more crucial than ever. Traditional analytics tools often require users to know precisely what they are searching for, which can limit their ability to uncover valuable patterns or emerging issues.

In recent years, generative artificial intelligence (AI) models (sometimes referred to as GenAI models) have helped in this regard, although they have their limitations. A generative AI model refers to a computational system that utilizes deep learning and a large number of parameters (e.g., billions or trillions for a large version and fewer for a small version) and is trained on one or more extensive datasets to produce coherent, contextually relevant, and fluent outputs (e.g., text and/or images) specific to a particular topic.

Large language models (LLMs) and other generative AI models have demonstrated strong reasoning abilities, enabling them to plan and interact with a large corpus of tools and applications. This has led to the development of LLM-based agents to enhance the capabilities of LLMs and other models and have become an increasingly common tool for task delegation, assisting with a wide range of requests by generating responses, interacting with user proxies, and producing final action plans. For example, LLMs (and other generative AI models) and LLM-based agents are currently employed to perform a wide variety of tasks, such as providing responses to various queries and prompts.

By themselves, generative AI models are great for many things, but they are only as good as the information available to them. In many cases, they do not have access to some information that might affect their reasoning in particular cases. For example, generative AI models may not have access to prior inquiries or searches performed by a user or insights previously determined by the user or even by the generative AI model that may be relevant to a current generative AI model session involving the user. Without access to that data, the information provided by the generative AI model to the user might be less helpful than it could be.

### BRIEF SUMMARY

In some embodiments, a generative AI system generates a set of insight archives based on previous generative AI model sessions, encapsulating documents, data, and insights associated with those sessions. Subsequent generative AI model sessions may leverage information stored within the insight archives, e.g., through processes like data extraction, interpolation, and conversion to alternative formats such as presentation slides, reports, or summaries. Generative AI systems, generative AI models, and generative AI model sessions may also be referred to herein as “AI systems”, “AI models”, and “AI model sessions”, respectively. Generative AI model sessions may also be referred to herein as simply “sessions.”

In some embodiments, a prompt is received by a computer. The prompt is provided as an input to a generative AI model during a session associated with the generative AI model. A first set of information is obtained from a first insight archive by the computer in response to receiving the prompt, the first set of information having been extracted from a prior session associated with the generative AI model and stored in the first insight archive. The first insight archive includes data and one or more documents associated with a first insight. A second insight is interpolated based on the first set of information obtained from the first insight archive. A second set of information is extracted based on the prompt and the second insight. The second set of information is stored by the computer in a second insight archive.

In other embodiments, a first prompt is received by a computer. The first prompt is provided as a first input to a generative AI model during a first session associated with the generative AI model. A first set of information is extracted based on the first prompt. The first set of information is stored by the computer in a first insight archive that is associated with a first insight. A second prompt is received by the computer. The second prompt is provided as a second input to the generative AI model during a second session associated with the generative AI model. The first set of information is obtained from the first insight archive by the computer in response to receiving the second prompt. A second insight is interpolated based on the first set of information obtained from the first insight archive. A second set of information is extracted based on the second prompt and the second insight. The second set of information is stored by the computer in a second insight archive.

In yet other embodiments, a first set of information is obtained from a plurality of insight archives by the computer, the first set of information having been extracted from a prior session associated with the generative AI model and stored in the first insight archive. The plurality of insight archives are respectively associated with a plurality of insights. A first insight is interpolated based on the first set of information obtained from the plurality of insight archives. The first insight is not included in the plurality of insights. A session associated with a generative artificial intelligence (AI) model is initiated based on interpolating the first insight. A prompt is received by the computer. The prompt is provided as an input to generative AI model. A second set of information is extracted based on the prompt and the first insight. A first insight archive is created by the computer. The first insight archive is not included in the plurality of insight archives. The second set of information is stored by the computer in the first insight archive.

In yet other embodiments, a request to provide a set of information in a first format is received by a computer. A set of information is obtained from an insight archive by the computer in response to receiving the request, the set of information having been extracted from a prior session associated with a generative AI model and stored in the first insight archive. The set of information is converted by the computer into the first format. The set of information is provided by the computer as an output in the first format.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment that supports generative AI insight archives in accordance with one or more embodiments;

FIG. 2 illustrates an example process that supports generative AI insight archives in accordance with one or more embodiments;

FIG. 3 illustrates another example process that supports generative AI insight archives in accordance with one or more embodiments;

FIG. 4 illustrates another example process that supports generative AI insight archives in accordance with one or more embodiments; and

FIG. 5 illustrates an example computer system that supports generative AI insight archives in accordance with one or more embodiments;

FIG. 6 illustrates an example scenario that supports generative AI insight archives in accordance with one or more embodiments; and

FIG. 7 illustrates an example of a portion of an insight archive that supports generative AI insight archives in accordance with one or more embodiments.

### DETAILED DESCRIPTION

The present disclosure relates to generative AI insight archives. In particular, the present disclosure relates to systems, methods, and computer-readable media for creating and using insight archives in conjunction with generative AI models (e.g., a general-purpose generative AI model or large language model (LLM)) to capture, store, and export insights.

Insight archives may be both efficient and versatile, designed to capture, store, and export insights, e.g., derived from generative AI model sessions. By utilizing a hybrid approach, an insight archive may store core information for quick access while retaining attachments that provide full context. The structure may allow for seamless integration of insights from multiple generative AI model sessions, which may facilitate a comprehensive understanding of evolving topics.

As generative AI model sessions progress, an insight archive may support merging of insights from different sessions. This may allow for related insight archives to be updated and modified to reflect the latest findings. This may enhance the richness of the insights and may preserve the historical context (e.g., through timestamps), allowing users to effectively track changes over time.

The use of insight archives as discussed herein may provide many benefits. One benefit is increased efficiency. By using stored insights, the AI system can quickly generate relevant responses without reanalyzing the same data repeatedly. Another benefit is better contextual understanding. The AI system can build on previous insights, providing more accurate and contextually relevant information. Another benefit is more comprehensive storage. Insight archives store core insights as well as contextual information, making it easy to access and understand the full picture. Another benefit is enhanced usability. Insight identity and aliases make it easy for users and search algorithms to recognize and reference specific insights. Another benefit is improved searchability. Additional information such as descriptions, findings, narratives, and metrics enhances the searchability and usability of the insight archives. Another benefit is more seamless sharing. The ability to export and share insight archives with user-friendly filenames ensures that insights can be easily carried and shared by users. Another benefit is format flexibility. The ability to convert information in insight archive files into different formats such as presentations, analysis papers, and reports allows users to present and share insights in various ways suitable for different audiences and purposes. Other benefits may be realized by embodiments of the invention, as discussed herein,

As illustrated in the foregoing discussion, the present disclosure utilizes a variety of terms to describe features and advantages of one or more embodiments of a generative AI system described herein. Additional detail will now be provided regarding the meaning of some of these terms.

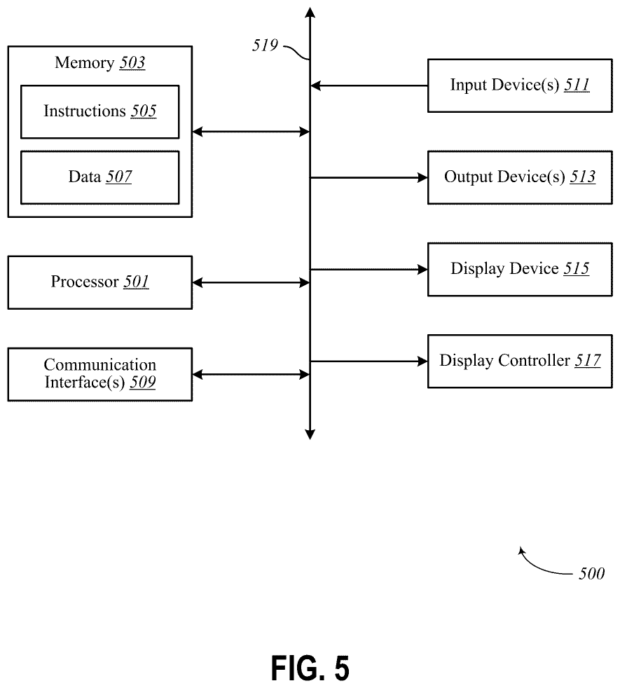

As used herein, a client or client device may refer to any type of electronic device or client application capable of sending and receiving data over a network. In one or more embodiments, the client or client device refers specifically to a mobile device such as a mobile telephone, a smart phone, a personal digital assistant (PDA), a tablet, a laptop, or a wearable computing device. In one or more embodiments described herein, a client or client device refers to a mobile device having a touch screen interface whereupon selectable icons can be presented and selected by a user of the client device. Indeed, as will be discussed in connection with one or more embodiments described herein, a client or client device may provide an interface through which a user may interact with a generative AI system, both in providing inputs (e.g., prompts during a generative AI model session) and as receiving outputs. Additional detail in connection with an example computing device that may refer to an example client or client device is discussed below in connection with FIG. 5.

As used herein, an insight refers to an understanding of a concept (e.g., an idea, situation, or problem). For example, an insight may be a recent realization or new perspective (e.g., a previously unknown realization or perspective) that clarifies something complex or sheds light on one or more underlying patterns. For example, “your trip from Austin to Houston on Jan. 15, 2024, stands out for its remarkable fuel efficiency,” “users reported frequent disconnections and slow network speeds from Apr. 1, 2024 to Jun. 20, 2024,” and “your blood pressure has improved significantly since you made dietary adjustments and increased your physical activity,” are three examples of insights in accordance with one or more embodiments. An insight may refer to a recognized connection(s) or pattern(s) within information or experiences. A new insight may involve determining a new understanding or finding of a pattern or issue or event by analyzing existing data. An insight may result from deeper analysis or may align with natural understanding. Insights may provide value by interpreting data or observations in ways that are actionable or reveal hidden opportunities. An insight may feel spontaneous or novel, offering a fresh angle or solution not previously considered. Insights may be interpretations that go beyond raw facts, providing a layer of meaning that aids comprehension, decision-making, or problem-solving. Insights may occur in many contexts in which gaining “insight” means discovering valuable information that leads to a new understanding or approach. For example, insights may occur in the context of business, psychology, data analysis, and innovation. In the context of generative AI models, an insight may refer to an understanding of a concept drawn from or otherwise derived from data generated by the generative AI model (or other AI model(s)). This may include pattern recognition, predictive insights, new content (e.g., text, images, designs), or identified optimizations to processes or systems.

Insights may be dynamic and situational. An insight may emerge from the analysis of data and often reveal something specific, unexpected, or actionable that may not have been obvious at first glance. An insight may provide clarity on a unique situation or event, transforming raw data and existing knowledge into meaningful conclusions that can guide decisions or highlight opportunities. Insights may be time-sensitive and may be unique to particular conditions, contexts, or periods.

An insight may also refer herein to a structured data representation within an insight archive. Knowledge may serve as baseline information against which insights are derived, contextualized, or compared. The insight itself becomes a valuable piece of understanding within this larger framework of knowledge, marked by its specificity, relevance, and potential for actionable outcomes. By isolating insights as distinct units within insight archives, the insight archives may provide for on-demand reference, cross-comparison, and/or integration by AI, all while preserving the original contextual details that enhance their value. An insight may capture specific findings derived from data analysis or events that hold meaningful significance within a particular domain. Insight archives are crafted to encapsulate relevant metrics, events, and context, distilling complex information into an understandable and actionable form. Within insight archives, each insight functions as a self-contained unit of domain-specific knowledge, detailing essential aspects such as time frames, key performance indicators (KPIs), findings, and narratives that explain underlying patterns, opportunities, issues, or trends identified within the data.

An insight may also function as a point of reference for insight identities, which may be memorable tags linked to key events or contexts that may help users access, relate to, and understand the insight quickly. An insight may be designed to be reusable, enabling its content to be referenced, compared, and built upon for further analyses, storytelling, and/or predictive modeling. This structure may ensure that insights are preserved for future reference and accessible for integration by generative AI systems, which may interpret and utilize these insights in various formats or generate new knowledge from them.

As used herein, a “generative AI model session” (or “AI model session” or simply “session”) refers to a period of indeterminate time in which a series of prompts are provided as inputs to a generative AI model and the generative AI model provides responses as output, based on the inputs. In one or more embodiments, a generative AI model session refers to a set or series of prompts in which outputs generated from one or more prompts may rely on information or insights interpolated or otherwise obtained from previous prompts and associated outputs (e.g., within the same AI model session). In this disclosure, “extraction” may refer to an ability to identify and retrieve information associated with an insight from a generative AI model session.

The process of interpolation is used in the present application for generating new insights, e.g., by referencing stored historical data, from previous generative AI model sessions. As used herein, “interpolation” refers to the process of merging, contextualizing, and/or synthesizing pieces of related information into a cohesive understanding (e.g., into an insight or other concept). The process of interpolation may also include ensuring that both historical and new data retain their relevance. In some examples, this may be done by introducing new elements into an existing framework to enhance, clarify, or extend its functionality, coherence, or informational completeness. For example, interpolation may involve integrating new insights or data into an existing insight archive to refine or expand the understanding of an event, process, or phenomenon. The process of interpolation does not merely append information; it synthesizes new and old insights to bridge understanding gaps across time, context, and dimensions. For example, when a previous insight archive has been created to encapsulate an insight, subsequent insights or additional data may enhance an existing narrative, add a new perspective or dimension (e.g., time, geography, related insight identity) not considered before, and/or shift the context by introducing new insight identities or aliases. In addition, Interpolation may be used to keep track of how an insight evolves and cause related insights to be connected logically, creating a coherent map of relationships.

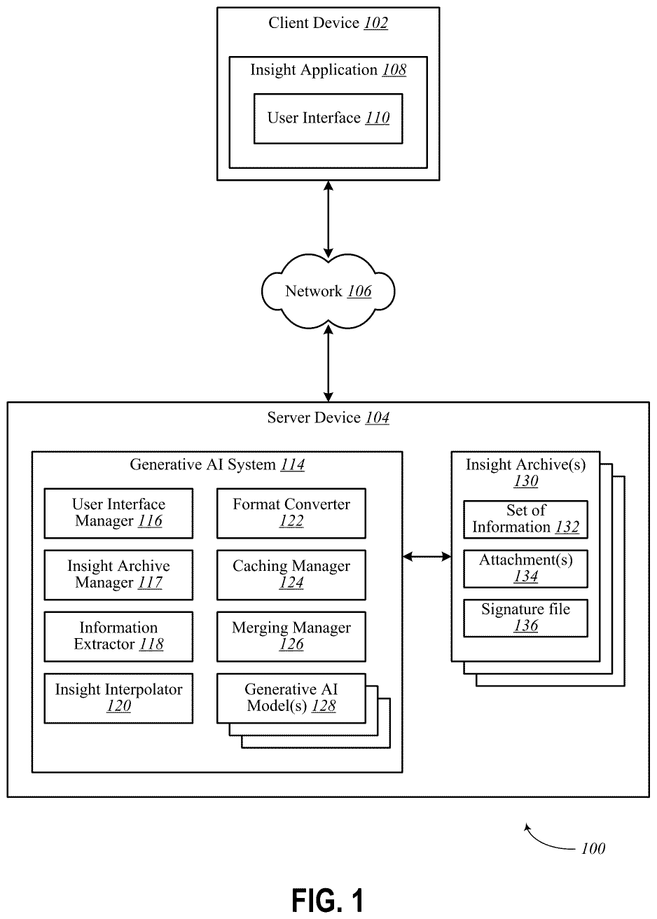

Additional details regarding example implementations of a generative AI system will now be discussed in connection with one or more example implementations shown in the figures. For example, FIG. 1 illustrates an environment 100 including a client device 102 in communication with a server device 104 via a network 106.

The client device 102 may refer to a physical client device, such as a laptop, mobile device, or other user electronic device. Alternatively, the client device 102 may refer to a remote device, such as a server or computing device that is hosted by a cloud computing system.

The server device 104 may refer to a server node or other computing device that is hosted on a network and which includes or otherwise provides access to one or more generative AI systems. In some examples, the server device 104 may be hosted on a cloud computing system.

The network 106 may refer to one or more networks and may use any communication platforms or technologies suitable for transmitting data. Indeed, the network 106 may refer to any data link that enables transport of electronic data between devices and/or modules of the environment 100. In one or more embodiments, the network 106 includes the Internet.

The client device 102 may include an insight application 108. The insight application 108 provides client-facing functionality of a generative AI system, as discussed herein. In one or more embodiments, the insight application 108 refers to a software application or a web application that provides the client-facing functionality of one or more embodiments described herein.

The insight application 108 may include a user interface 110. The user interface 110 provides an interface through which a user of the client device 102 interacts to provide input from the user to the generative AI system and provide output from the generative AI system to the user. In some examples, the user interface 110 may refer to a web browser or software program interface through which a user may provide the input or receive the output. In some examples, the user may compose a prompt and submit the prompt to a generative AI model. In some examples, the user interface 110 may enable a user to provide any user-composed or user-selected information that may be used in performing various tasks and to receive and view outputs of the generative AI system.

The server device 104 may include one or more insight archives 130. The insight archives 130 are archive files that store insights and associated information derived from user interactions with generative AI systems 114. Each insight archive 130 may be structured to accommodate multiple files and folders, making the insight archive 130 a versatile container for various types of data associated with insights. The insight archive may be a self-contained unit storing all the information, including documents, associated with an insight. This may allow the insight archive to be easily exportable and sharable. In some examples, the insight archives may be implemented as files having containers for containing other files. This may allow the insight archives to be accessed in a comparable manner to other files.

A strategic storage approach may be employed to optimize data management using insight archives. For example, a strategic separation between core insights and contextual information related to the insights may be used. Using this strategic storage approach, core insights—such as findings, metrics, and narratives—may be embedded directly within the insight archive, e.g., in metadata. This may allow for rapid access to the core information, enhancing efficiency in data retrieval. By keeping the core insights readily available, users may quickly gain an overview of the insight analysis without sifting through additional files or attachments. A structured nature of the metadata may also facilitate automated processing. This may enable generative AI systems to seamlessly integrate insights into responses (e.g., during generative AI model sessions), thereby improving user interaction and engagement.

Each insight archive may include an insight identity that may enhance recognition and usability. The insight identity may be an intuitive and memorable identifier, e.g., for memorable events, which may make it easier for users to reference and recall specific insights. The insight identity may serve as a user-friendly identifier that enhances the usability and effectiveness of the insight. For example, an insight name may be suggested by the user during a session when the new insight is determined (e.g., in response to a request by the generative AI model). This name may be used as the filename of the new insight archive when it is stored. This may make it easier for users to identify and share the insight archive. For example, an insight identity of “Battery Life Issues—March 2024” may be used for an insight associated with customer feedback in March 2024 related to battery issues.

Contextual information associated with the insights may be incorporated as attachments in the insight archives. For example, full conversation transcripts, images, PDFs, and other supplementary files may be stored as attachments within the insight archives. These attachments may preserve the context of discussions and analyses, which may enable users to delve deeper into the insights when desired.

This strategic separation between core insights and contextual information may allow core insights to be streamlined for quick access, while preserving the broader context in external files. Users may reference the attachments for detailed review or clarification, which may facilitate a comprehensive understanding of the insights in their entirety. This approach may not only maintain richness of the data but also support various use cases, from quick analysis to in-depth exploration.

By utilizing this strategic storage approach, the insight archives may strike a balance between efficiency and comprehensiveness. This may allow users to have immediate access to core insights, while allowing users the ability to explore the full context when desired. This structure may enhance the overall user experience, allowing for both quick decision-making and thorough analysis.

In some examples, an insight archive 130 may be associated with a single insight. In some examples, an insight archive 130 may be associated with multiple insights. In some examples, an insight archive 130 may be created by the generative AI system 114. In some examples, the insight archives 130 may support offline capabilities. This may allow for faster retrieval of data without depending on multisystem architectures. The insight archive may have a structure that allows core insights to be captured while also storing attachments to provide additional context.

The insight archive 130 may include a set of information 132 associated with an insight. This set of information 132 may be used for understanding the relevance and timing of the insight derived from the generative AI model sessions, as well as indicating related insights. The information may improve the searchability and usability of the archive by providing context and detailed insights. In some examples, some or all of this information may be stored as metadata of the insight archive 130. By way of example only, the set of information may include one or more of the following information. It is appreciated that other information may also be included in the set of information.

The set of information 132 may include an identifier of the insight archive. For example, the set of information may include the insight identity. As discussed above, the insight identity may be a user-friendly identifier that may be used as the filename of the insight archive.

The set of information may include information for cross-referencing to other insight archives. For example, the set of information may include one or more aliases related to the insight. The aliases may be insight names (e.g., insight identities) of other insights that are related to the insight. This may facilitate easy recognition and cross-referencing, Using the aliases, a user may quickly and easily obtain and review related insights, thereby enhancing the user's knowledge on the subject.

The set of information may include a description of the insight. The description may include, e.g., a summary of the content and purpose of the insight archive.

The set of information may include one or more findings related to the insight. The findings may highlight, e.g., key insights and conclusions derived from the insight data.

The set of information may include one or more narratives related to the insight. The narratives may include, e.g., detailed explanations of the insight and their implications or descriptive accounts that may provide a contextualized interpretation.

The set of information may include metrics related to the insight. The metrics may include, e.g., quantitative data and measurements that support the findings.

The set of information may include one or more timestamps. For example, timestamps may be included for indicating when modifications are made to the file, periods when analysis was performed, etc.

The set of information may include one or more domain contexts. The domain contexts may include, e.g., relevant domain or industry context(s) in which the insight was generated.

The set of information may also include information related to revisions, attachments, or signatures, as discussed below.

The insight archive 130 may also include other information related to the attachments and signature file, discussed below. In some examples, an insight archive 130 may include multiple sets of information 132, each corresponding to a different insight.

The insight archive 130 may support multiple revisions of an insight. This may allow users to capture updates and improvements over time and mitigate stale data. For example, for each revision, changes made to an insight or its associated data may be documented, providing a history of modifications. To facilitate this, the set of information 132 may include information associated with revisions of the insight archive. For example, the information may include, for each revision, one or more of: a revision ID, a timestamp indicating when the revision was made, and/or a description of the revision that was made.

The insight archive 130 may include one or more attachments 134 (e.g., files) related to the insight. The attachments 134 may include, e.g., transcripts, images, PDFs, spreadsheet data, and other relevant documents. In some embodiments, the attachments 134 are organized into folders within the insight archive 130. This structure may allow for the preservation of full context and supporting materials, providing pertinent information related to the insights to be readily accessible. In some embodiments, the set of information 132 in the insight archive 130 includes information associated with the attachments 134. For example, the set of information 132 may include, for each attachment, one or more of a type of the attachment (e.g., image, transcript, document, etc.), a file type of the attachment (e.g., plain text, Word, type of image, etc.), a purpose of the attachment (e.g., why the file is included and how it relates to the insight), and/or a file path (e.g., the location of the file within the system).

The insight archive 130 may include a signature file 136 for verifying the integrity of the data and/or attachments within the insight archive 130. The signature file 136 may be used to maintain the security and reliability of the insight archive 130. By providing a digital signature, the signature file 136 may allow users to confirm that data has remained intact and unaltered in the insight archive 130 since the insight archive's creation. This feature may be especially useful, e.g., with insight archives that contain financial records, legal documents, or sensitive analyses. The use of cryptographic signatures may help to safeguard against unauthorized changes, ensuring that the insights derived from an insight archive are both trustworthy and reliable. The signature file 136 may include one or more of a hash value, an identifier of an algorithm to be used to generate the signature, an identifier of one or more parties responsible for signing the file, and/or a timestamp associated with the signature file. In some examples, the signature file may be incorporated into the set of information 132.

The insight archive 130 may include privacy controls to help prevent private information from being accessed. For example, private information in an insight file may be identified as such. Then, when the insight archive 130 is accessed, information that is identified as private may not be used and may be hidden from view. Other manners of handling private information may alternatively be used.

Because the insight archives include all the information, including documents, associated with the insight, the insight archives may be self-contained units. That may allow the insight archives to be easily exportable and sharable with others. For example, the insight archives may be shared for team collaboration and/or reusability. This may allow a team to benefit from insights created by individual users, fostering collaboration and enhancing overall productivity. The insight identity, which may be used as the filename, may aid in this, making the insight archive easily recognizable and usable by both people and search algorithms. The relevant aliases identified within an insight archive may allow for other insight archives related to the insight archive to also be easily exported and shared. Further, the information included in the insight archive file may be converted into different file formats such as presentations, analysis papers, and reports, as discussed in more detail below. This flexibility may allow insights to be presented and shared in various formats suitable for different audiences and purposes.

In some embodiments, comparative analyses may be performed between insight archives. For example, a comparative analysis may be performed between two closely related insight archives. The analyses by help users generate actionable outcomes and make informed decisions. For example, a user may draw comparisons between different data sets or insights, which may enable them to identify patterns, trends, and discrepancies across various contexts. By comparing different data sets, users may identify patterns, trends, and discrepancies that may not be apparent when looking at a single data set. This comprehensive understanding may aid in strategic decision-making and in uncovering insights that drive business improvements.

As discussed in more detail herein, interpolation may be used to generate new insights by referencing stored historical data from previous AI model sessions. Comparative analysis and interpolation may serve different purposes. For example, interpolation may be generally used more to fill in gaps and create new data points from existing information rather than comparing different sets of data. Interpolation is used to generate new insights by leveraging existing data, while comparative analysis is used to identify differences and similarities between multiple data sets or insights. Interpolation involves creating new data points based on existing patterns, whereas comparative analysis involves directly comparing different data sets to find patterns, trends, and discrepancies. The outcome of interpolation may be a new insight that fits within the existing data framework, while the outcome of comparative analysis may be a deeper understanding of the relationships and differences between various data sets.

In some embodiments, insight archives may enhance generative AI model sessions. For example, using an insight archive, a generative AI model may initiate a conversation with a user, pitching information about an insight that has been recently discovered, e.g., by a peer or an automatic system. This may allow a deeper engagement to occur between users and the AI model. For example, the AI model may point out key items that the user might want to know. Users may further ask the AI model for more information, and the AI model may bring the attachments and metrics to display on the screen. This proactive approach may ensure that users are continuously informed and engaged with the data, potentially making the interaction more dynamic and valuable.

Another example of insight archives enhancing generative AI model sessions is that the use of insight archives may reduce “hallucinations” in responses from AI models. Hallucinations are responses generated by AI models that may sound real, but that are actually wrong (e.g., fabricated) or misleading. As is known in the art, hallucinations may occur infrequently, but frequent enough to be of some concern. Generative AI models may lack precise data context for producing consistently accurate insights, leading to errors that may undermine user trust. The insight archives may address this challenge by serving as a stable, structured “source of truth” for AI-driven analytics systems. Each insight archive may function as a self-contained archive that may include standardized elements such as those discussed above. This detailed, layered structure may allow AI systems to access and interpret contextual information associated with each insight. By anchoring the responses in this structured data, the insight archive may enable AI systems to provide more relevant, accurate answers and reduce the likelihood of hallucinations that can occur when context or factual details are missing.

In some embodiments, the insight archive design may incorporate a file structure resembling an “airplane black box” concept, which may enhance the portability and integrity of insights across systems. This design may make it ideal for complex domains, such as financial analysis, manufacturing, or diagnostics, where reliable, contextualized data may be used by AI systems to support high-stakes decision-making.

The insight archive provides a novel approach that improves AI reliability by ensuring that insight data is not only accessible but interpretable, minimizing the AI's reliance on assumptions or incomplete information. In essence, the insight archive may play a transformative role in generative AI, enabling systems to deliver more accurate, dependable insights across industries by fundamentally reducing the risk of hallucination. This structured format establishes a replicable, scalable way to ground AI responses in real data, which may position it as a foundational component for future analytics-driven AI solutions.

The server device 104 may include a generative AI system 114. The generative AI system 114 captures and stores insights generated from interactions with generative AI models and determines new insights based on the stored insights. The generative AI system 114 stores and retrieves these insights to/from the insight archives 130. The generative AI system 114 may allow for seamless exportation, sharing, and internal storage for fast access to insights derived from AI-driven inquiries.

In some embodiments, the generative AI system extracts insights from generative AI model sessions and stores the insights within an insight archive 130. In some embodiments, subsequent sessions reference this data, interpolating new insights based on historical information. This may reduce the need to recompute or fetch the same data multiple times, thereby causing the computer on which the sessions run to be more efficient and perform faster. For example, if a number of users want to obtain information about a same subject using a generative AI model (e.g., in an educational environment: after a class discussion or in response to a homework assignment), each user might conduct their own session. Instead of each session recomputing the same information multiple times, as is done conventionally, each session may obtain the information by referencing the insight archive 130. This saves processor time and power and allows the computer to run more efficiently.

The generative AI system 114 may make use of one or more generative AI models 128 to perform features and functionalities of the generative AI system 114 as discussed herein. As discussed above, a generative AI model refers to a computational system that utilizes deep learning and a large number of parameters and is trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For example, generative AI models may create outputs in various formats, e.g., one-word answers, long narratives, images, videos, labeled datasets, documents, tables, and presentations.

The one or more generative AI models 128 may be based on transformer architectures for understanding, generating, and manipulating human language. Generative AI models 128 may utilize other types of architectures such as recurrent neural network (RNN) architecture, long short-term memory (LSTM) model architecture, convolutional neural network (CNN) architecture, or other types of architectures. Examples of generative AI models that may be used as generative AI models 128 include generative pre-trained transformer (GPT) models (e.g., GPT-3.5, GPT-4, and GPT-4o), bidirectional encoder representations from transformers (BERT) models, text-to-text transfer transformer models (e.g., T5), conditional transformer language (CTRL) models, and Turing-NLG. Other types of generative AI models that may be used as generative AI models 128 include sequence-to-sequence models (Seq2Seq), vanilla RNNs, and LSTM networks. Other types of generative AI models may also be used.

In some embodiments, a generative AI model 128 includes a large language model (LLM), a small language model (SLM), a large action model (LAM), and a small action model (SAM), which serve as text-based versions of a generative AI model, such as those that receive text prompts and/or generate text outputs. In some embodiments, a generative AI model is a multimodal generative model that receives multiple input formats (e.g., text, images, video, data structures) and/or generates multiple output formats. In some embodiments, the generative AI system utilizes one or multiple LLMs to generate outputs based on input prompts. In some embodiments, the one or more generative AI models 128 refer to LLMs that are capable of analyzing language and generating a wide variety of outputs.

In one or more embodiments, the generative AI system 114 employs a generative AI model 128 (e.g., a user-facing generative AI model) to conduct one or more generative AI model sessions with a user. As noted above, a session refers to a period of indeterminate time in which a series of prompts are provided as inputs to a generative AI model and the generative AI model provides responses as output, based on the inputs.

In some embodiments, the session is initiated by the generative AI system 114 in response to receiving a session request, e.g., from a user (e.g., at a client device 102). During a session, the generative AI model 128 may generate responses to prompts received from the user and provide the responses to the user. The user may compose an inquiry (e.g., as a prompt) that is provided to the generative AI model 128 as an input. The generative AI model 128 may compose a response based on the input and the response is provided as an output to the user. This back and forth between the user and the generative AI model 128 may continue until the session is ended. The generative AI model 128 may consider previous prompts within the same session to build additional context and further inform the generative AI model 128 on context or information that can be considered in generating subsequent responses.

In one or more embodiments, a session has a capped number of prompts and corresponding responses that may be generated. In some embodiments, the generative AI model session operated under a token-based system, where each input and output is measured in tokens. The session may have a capped number of tokens or other processing units that may be used by the generative AI model. A token may represent a piece of text, such as a word or a character. When a user makes inquiries in the generative AI model session, tokens may be consumed based on the length and complexity of the inputs and outputs of the session.

In some examples, one or more of the components of the generative AI system 114 may be incorporated into or performed in conjunction with a generative AI model 128. For example, one or more of: the user interface manager, the insight interpolator, information extractor, format converter, caching manager, or merging manager, discussed below, may be incorporated into or performed in conjunction with one or more generative AI models 128. It will be appreciated that the one or more generative AI models 128 may refer to a single model or different models or different types of models capable of performing respective tasks of the generative AI system 114 described herein. In one or more embodiments, the one or more generative AI models 128 refer to LLMs that are capable of analyzing language and generating a wide variety of outputs.

The generative AI system 114 may include a user interface manager 116. The user interface manager 116 manages display of inquiries (e.g., prompts) and/or output of the generative AI system 114 to the user of the client device 102. In some embodiments, the prompts and output correspond to a generative AI model 128. For example, the prompts and output may be displayed to the user as part of a generative AI model session. In some embodiments, the prompts and output additionally or alternatively correspond to other than a generative AI model. Indeed, the user interface manager 116 may facilitate any features and functionality related to providing a display of an interface that enables a user to interact with icons, compose text, or otherwise interact with a prompt interface and/or feedback tools that are presented via a graphical user interface (GUI) of the client device(s) 102.

The generative AI system 114 may include an insight archive manager 117. The insight archive manager manages the insight archives 130. For example, any obtaining (reading) of data from the insight archives or storing (writing) of data to the insight archives is done via the insight archive manager 117. The insight archive manager 117 also manages the creation and deletion of insight archives.

The generative AI system 114 may include an information extractor 118. The information extractor identifies and retrieves insights from generative AI model sessions. For example, when a user submits an inquiry (e.g., poses a question during a prompt), the information extractor 118 may analyze the inquiry and capture relevant information, such as trends, metrics, or findings. In one or more embodiments, the information extractor 118 stores the extracted information in an insight archive 130, to create a repository of insights that may be referenced later. In some embodiments, the information extractor 118 extracts information based on one or more prompts, e.g., during a generative AI model session. In some embodiments, the information extractor 118 additionally or alternatively extracts information based on an insight, e.g., from an insight interpolator. In some embodiments, the information extractor 118 extracts the information in response to the generative AI system receiving a prompt, e.g., during a generative AI model session. In some embodiments, the information extractor 118 creates a new insight archive 130 in which to store the extracted information, for example when the insight interpolator determines a new insight.

The generative AI system 114 may include an insight interpolator 120. The insight interpolator 120 determines new insights by referencing stored historical data. For example, the insight interpolator 120 may interpolate an insight based on a set of information in an insight archive 130. In some embodiments, the insight interpolator 120 obtains the set of information from one or more insight archives 130. In some embodiments, the insight interpolator 120 determines the insight also based on one or more inputs from a user. In some embodiments, the inputs from the user include a prompt received from the user as an input of a generative AI model session. In some embodiments, the insight interpolator 120 obtains the set of information in response to the generative AI system 114 receiving a prompt, e.g., during a generative AI model session. In some embodiments, the insight interpolator 120 outputs the interpolated insight to the user, e.g., during a generative AI model session. In some embodiments, the insight interpolator 120 determines that the insight is a new insight.

When subsequent generative AI model sessions are conducted by the generative AI system 114, the generative AI system 114 may leverage previously extracted insights to provide contextual answers or extend the analysis. This process allows the generative AI models 128 to make informed inferences, enhancing the richness and relevance of responses without reanalyzing the original data.

The generative AI system 114 may include a format converter 122. The format converter 122 converts insight information into one or more various output formats and provides the information, e.g., to a user, in the output format. In some embodiments, the output format is a format requested by the user. In some embodiments, the information is stored in an insight archive 130. In some embodiments, the format converter 122 obtains the information from the insight archive 130. In some embodiments, the information obtained from the insight archive 130 was previously extracted (e.g., from a prior session of a generative AI model) and stored in the insight archive 130. In some examples, the requested format may be one or more of: presentation slides (e.g., PowerPoint® slides), reading documents (e.g., Word documents), or spreadsheets (e.g., Excel® spreadsheets). Other formats are also possible.

These conversions may enhance usability for different contexts. Different stakeholders may benefit from tailored presentations. For example, presentation slides (e.g., in PowerPoint® format) may be useful, e.g., for visual presentations, summarizing key points with bullet points and charts. Reports (e.g., in Microsoft® Word format) may be useful, e.g., for providing comprehensive analysis for stakeholders needing thorough documentation. Summaries (e.g., in Microsoft® Word format) may offer overviews of insights and may be useful, e.g., for high-level discussions.

Conversion of insight archive data into these output formats may provide many benefits, such as minimal overhead, streamlined workflows, dynamic content presentation, and support for collaboration. For example, this efficient conversion process may allow for rapid reformatting without extensive computational resources. Users may generate alternative output swiftly, adapting insights for various audiences or purposes with minimal delays. By facilitating easy conversion, the generative AI system 114 may help streamline workflows. Users may quickly gather insights for meetings or reports, reducing preparation time and effort. The format converter 122 may reformat insights to include data visualizations, catering to different preferences for information consumption. This adaptability may enhance effective communication of insights. Easy reformatting may enhance collaboration across teams. Different teams may leverage the same underlying data while tailoring presentations to the teams' unique needs.

The generative AI system 114 may include a caching manager 124. The caching manager 124 manages caching during generative AI model sessions. Caching involves storing precomputed insights and data so that when a user requests information (e.g., in a prompt), the generative AI model may quickly access these stored results instead of performing complex calculations or data retrieval processes anew. The caching manager 124 may cache inquiries and insights for specific topics based on relevance. This may enable frequently asked questions or high-priority topics to be readily available. The caching system may be flexible, allowing users to prioritize or archive topics.

Caching data during generative AI model sessions may provide many benefits. For example, doing so may conserve generative AI tokens. As discussed above, generative AI models may operate under a token-based system, where each input and output is measured in tokens. When a user makes inquiries in a generative AI model session that require re-evaluating extensive datasets or generating new insights, tokens may be consumed. By caching insights, the amount of recomputing these responses may be reduced. Instead, the generative AI system 114 may serve cached results directly to the session, thus conserving generative AI model tokens that would otherwise be spent on recalculating or generating similar insights.

Another benefit of using caching may be faster response times. By implementing efficient caching strategies, the generative AI system may significantly enhance the speed of generating responses during user sessions with generative AI models. This may be particularly valuable when multiple sessions are related to similar topics or datasets. Instead of engaging in a resource-intensive process to repeatedly generate insights, the generative AI system 114 may quickly serve cached results to the sessions, improving overall user experience. Faster response times may translate to a smoother and more efficient interaction with the generative AI system. Users may access information more rapidly, which may be especially useful in scenarios where timely insights are used for decision-making. This efficiency may encourage continued engagement with the generative AI system, as users may rely on it for quick and accurate information without worrying about resource limitations.

A technical advantage may stem from an ability to reduce resource usage and provide fast, offline-capable responses by caching insights and associated data in a structured format. This approach may conserve processing power during generative AI model sessions, while also enabling relevant data to be quickly accessible for subsequent sessions.

The generative AI system 114 may include a merging manager 126. The merging manager 126 manages the merging of insight information associated with different insight archives. Insights often evolve through iterative discussions. When engaging with generative AI models, users may initiate multiple conversations on similar topics. To enhance clarity and organization of insights, embodiments of the present invention allow for merging of information associated with similar topics.

For example, as users delve deeper into related topics through additional generative AI model sessions, the generative AI system 114 may generate new insight archives. Each of these newly created insight archives may capture distinct insights and perspectives derived from their respective sessions. For example, a user might discuss “Viva Engage Effectiveness” in a first session and then explore “Influencer Communication Strategies” in a later session, resulting in separate insight archives for each topic.

The merging manager 126 allows users to merge insight archives to consolidate insights from multiple sessions when the insight archives include insights that are similar to each other. In one embodiment, one of the insight archives is selected to be the primary insight archive. The other, secondary, insight archives may contain related but distinct insights. Information from the secondary insight archives may be copied to the primary insight archive. The primary insight archive may then encompass the collective insights and associated information from all of the related sessions. In one embodiment, instead of copying information to the primary insight archive, the secondary insight archives are maintained and links to them are stored in the primary insight archive. In some examples, links to all the related primary and secondary insight archives may be stored in each of the primary and secondary insight archives.

The merging of insight archives associated with multiple conversations may streamline data management, enhance the richness and credibility of the captured insights, and promote effective data utilization. Further merging of insight archives may foster a more integrated understanding of topics, which may enable organizations to reduce redundancy, enhance clarity, and facilitate future reference. For example, by consolidating similar insights, users may avoid repetitive information and streamline their analyses; a unified primary insight archive may present a clearer picture, making it easier for stakeholders to grasp core insights and take actionable steps. Further, users may easily reference combined insights in future discussions or analyses. And allowing the evolution and integration of knowledge, organizations may maximize the value of their interactions with generative AI.

While the environment 100 shows two devices in communication with one another, this is provided as an example implementation that is not intended to be limiting to two devices. Indeed, one or more features described in connection with the components of the generative AI system 114 may be performed on the client device 102 or on separate server devices from the server device 104 shown in FIG. 1. As another example, one or more of the generative AI models 128 may be implemented on separate server devices 104. In one or more examples, the server device(s) 104 and any additional devices of the environment 100 may be implemented on a cloud computing system, with each of the features and functionalities being provided as distinct or combined services on the cloud. In one or more examples, the insight archives 130 may be implemented on one or more different server devices 104. In one or more examples, the insight archives 130 may be spread across a cloud computing system.

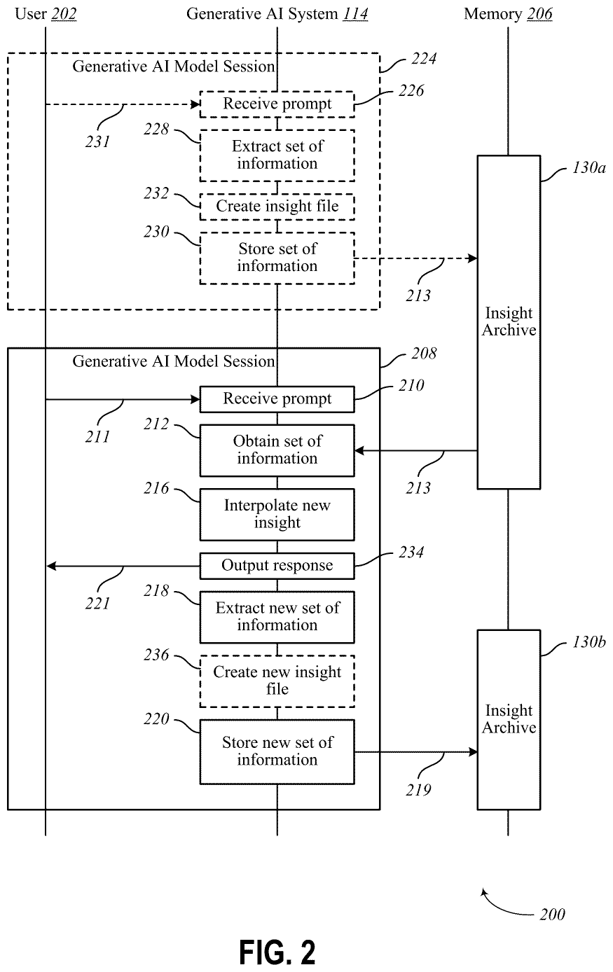

Additional information in connection with these and other examples will be discussed in further detail below (e.g., in connection with FIGS. 2-4)

In many embodiments discussed herein, insight archives are used by generative AI models during model sessions. The insight archives store information from previous model sessions, which are used to enhance future sessions. In many embodiments, at least the following acts may be performed during the model session: receiving prompts, extracting information, interpolating new insights, and storing the new insights in structured insight archives, as discussed below. In some of the embodiments discussed herein, all of these acts are shown. In others, one or more of the acts are omitted. It is appreciated that the acts may also be included in the embodiments in which they are omitted, where it makes sense. It is also appreciated that other acts, typical of generative AI model sessions, may also be performed in conjunction with the acts discussed below.

FIGS. 2-4 are process flow diagrams that illustrate example processes 200, 300, and 400 that support generative AI insight archives in accordance with one or more embodiments disclosed herein. In FIGS. 2-4, acts are performed by a generative AI system 114, in conjunction with information associated with a user 202 and memory 206. The generative AI system 114 may receive or obtain information from the user 202, or from insight archives 130 in the memory 206. The generative AI system 114 may output information to the user 202, or save information in the insight archives 130.

The generative AI system 114 and insight archives 130 may be examples of the generative AI system and insight archives discussed with respect to FIG. 1. It will be appreciated that the acts performed in these examples may each be performed by one or more of the components of the generative AI system 114, discussed with respect to FIG. 1.

FIG. 2 illustrates an example process 200 in which a new insight is determined during a generative AI model session by interpolating information that was extracted from a prior generative AI model session. This may provide seamless integration of insights from multiple generative AI model sessions, which may facilitate a comprehensive understanding of evolving topics.

In process 200, the generative AI system 114 obtains a set of information from an insight archive after receiving a prompt from a user during a generative AI model session, interpolates a new insight based on the set of information, extracts a new set of information based on the prompt and the new insight, and stores the new set of information in an insight archive. In some embodiments, the generative AI system 114 performs the prior generative AI model session to extract and save the original set of information. In some embodiments, the generative AI system 114 outputs the new insight to the user. In some embodiments, the application creates a new insight archive in which the new set of information is stored.

As shown in FIG. 2, a generative AI model session 208 is conducted between the user 202 and the generative AI system 114. The generative AI system 114 performs various acts during the session 208. For example, during the session 208, the generative AI system 114 may receive one or more enquiries (e.g., one or more prompts) from the user, process the enquiries through the generative AI model to generate responses, and outputs the responses to the user. The prompts may include questions or requests for information. The responses may include answers to the questions or information requests.

At act 210, the generative AI system 114 receives a prompt 211 from the user 202 during the generative AI model session 208. In some examples, the prompt may be a question or request for information. In some embodiments, the prompt 211 is provided as an input to the generative AI model. The operations of act 210 may be performed in accordance with examples as disclosed herein. In some examples, aspects of the operations of act 210 may be performed by a user interface manager 116 as described with reference to FIG. 1.

At act 212, the generative AI system 114 obtains a set of information 213 from an insight archive 130a. The insight archive 130 contains information (e.g., data and documents) from previous generative AI model sessions. Act 212 may be performed as a result of receiving the prompt 211 at act 210. In some embodiments, the insight archive 130a from which to obtain the set of information 213 is determined based on information in the prompt 211. For example, the insight archive may include information that is relevant to the prompt. In some embodiments, the insight archive 130a includes data and one or more documents associated with an insight. In some embodiments, the set of information 213 in the insight archive 130 has been previously extracted from a prior session associated with a generative AI model and stored in the insight archive 130a. The operations of act 212 may be performed in accordance with examples as disclosed herein. In some examples, aspects of the operations of act 212 may be performed by an insight archive manager 117 as described with reference to FIG. 1.

At act 216, the generative AI system 114 interpolates a new insight. The new insight is interpolated based on the set of information 213 obtained from the insight archive 130a at act 212. This may involve combining and analyzing the existing data to produce a new understanding or finding. The operations of act 216 may be performed in accordance with examples as disclosed herein. In some examples, aspects of the operations of act 216 may be performed by an insight interpolator 120 as described with reference to FIG. 1.

At act 234, the generative AI system 114 outputs a response to the user 202. The response may be based at least in part on processing the prompt 211 through the generative AI model associated with the session 208. The response may be based at least in part on the new insight. In some embodiments, the response includes the new insight interpolated at act 216. In some embodiments, the new insight is provided as an output of the generative AI model. The operations of act 234 may be performed in accordance with examples as disclosed herein. In some examples, aspects of the operations of act 234 may be performed by a user interface manager 116 as described with reference to FIG. 1.

At act 218, the generative AI system 114 extracts a new set of information 219. The new set of information may include additional information based, e.g., on the new insight and the prompt. This additional information may be used to enhance the current session 208. In some embodiments, the new set of information 219 is extracted based on the prompt 211 received by the generative AI system 114 at act 210. In some embodiment, the new set of information 219 is extracted based also on the new insight interpolated at act 216. In some embodiments, the new set of information 219 is based at least in part on the response output by the generative AI system 114 at act 234. In some embodiments, the prompt is one of a plurality of prompts received by the AI system 114 from the user during the session 208 and the response is one of a plurality of responses output by the generative AI system 114 during the session 224, and the set of information 213 is based at least in part on the plurality of prompts and the plurality of responses. In some embodiments, the new set of information 219 includes the new insight and information associated therewith. The operations of act 218 may be performed in accordance with examples as disclosed herein. In some examples, aspects of the operations of act 218 may be performed by an information extractor 118 as described with reference to FIG. 1.

At act 220, the generative AI system 114 stores the new set of information 219 in an insight archive 130b. This may ensure that the insight(s) generated during the session are preserved for future use. In some embodiments, the insight archive 130b includes a container in which the new set of information 219 is stored. In some embodiments, the insight archive 130b is the same insight archive as insight archive 130a. In that case, the new set of information 219 may be stored in the same insight archive as the set of information 213. In some embodiments, the insight archive 130b is a new insight archive, separate from the insight archive 130a. In that case, the new set of information 219 is stored in a different insight archive than the set of information 213. For example, the generative AI system 114 may determine that the new insight is to be stored in a new insight archive and create the new insight archive, as shown at act 236. In some embodiment, the new insight archive is created based on performing the interpolation at act 216 and before storing the new set of information. The operations of acts 220 and 236 may be performed in accordance with examples as disclosed herein. In some examples, aspects of the operations of acts 220 and 236 may be performed by an insight archive manager 117 as described with reference to FIG. 1.

In some embodiments, the generative AI system 114 also conducts the prior generative AI model session (session 224), performing acts 226, 228, and 230, and optional act 232. In some embodiments, the prior session 224 is conducted prior to the session 208.

At act 226, the generative AI system 114 receives a prompt 231 from the user 202 during the session 224. The prompt 231 may be similar to prompt 211. For example, the prompt may be a question or request for information. In some embodiments, the prompt 231 is provided as an input to the generative AI model during the session 224 associated with the generative AI model. The operations of act 226 may be performed in accordance with examples as disclosed herein. In some examples, aspects of the operations of act 226 may be performed by a user interface manager 116 as described with reference to FIG. 1.

At act 228, the generative AI system 114 extracts a set of information, which corresponds to the set of information 213. In some embodiments, the set of information 213 is extracted in response to receiving the prompt at act 226. In some embodiments, the set of information is extracted based on the prompt 231 received by the generative AI system 114 at act 226. In some embodiments, the prompt is one of a plurality of prompts received by the AI system 114 from the user during the session 224 and a corresponding plurality of responses are output by the generative AI system 114 during the session 224, and the set of information 213 is based at least in part on the plurality of prompts and the plurality of responses. The operations of act 228 may be performed in accordance with examples as disclosed herein. In some examples, aspects of the operations of act 226 may be performed by an information extractor 118 as described with reference to FIG. 1.

At act 230, the generative AI system 114 stores the extracted set of information 213 in the insight archive 130a. The insight archive 130a is associated with an insight. In some embodiments, the generative AI system 114 may first create the insight archive 130a before storing the set of information, as shown at act 232. In some embodiments, the insight archive 130a is created based on extracting the set of information 213 performed at act 228. The operations of acts 230 and 232 may be performed in accordance with examples as disclosed herein. In some examples, aspects of the operations of acts 230 and 232 may be performed by an insight archive manager 117 as described with reference to FIG. 1.

In some examples, the session 224 may include other, similar acts as those in session 208. For example, although not shown, the generative AI system 114 may also perform acts associated with obtaining a set of information, and/or interpolating a new insight based on the set of information, and/or outputting a response to the user in conjunction with the other acts of the session 224.

Although all of the acts of process 200 are shown as being performed in conjunction with generative AI model sessions, that is just one example. In other examples, one or more of the acts may be performed before or after a corresponding session. For example, one or more of acts 216, 218, 220, 234, or 236 may use information from session 208, but may be performed after session 208 has ended. Similarly, one or more of acts 228, 232, or 230 may use information from session 224, but may be performed after session 224 has ended.

In some examples, portions of the first session 224 and portions of the second session 208 may be performed sequentially. For example, in some embodiments, acts 226, 228, and 230 of the first session 224 are performed and then acts 210, 212, 216, 218, and 220 of the second session 208 are performed. For example, the set of information 213 may be extracted and stored in the insight archive 130a during the first session 224 (using acts 226, 228, and 230), and then during the second session 208, a new insight may be interpolated based on obtaining the set of information 213 from the insight archive 130a and the new set of information 219 may be extracted and stored in the insight archive 130b (using acts 210, 212, 216, 218, and 220).

We will now discuss an example scenario for process 200. In the example scenario, a generative AI model is used to analyze customer feedback for a product. During a session 208 with the generative AI model, the user may ask the generative AI model in a prompt 211, “What are the common issues customers have reported about our product in the last month?” The AI system may receive the prompt (act 210) and in response, retrieve a set of relevant data (set of information 213) from an insight archive 130a (act 212) that contains previous analyses of customer feedback. The AI system 114 may identify a new pattern from the retrieved data via interpolation (act 216), such as a recurring issue with the product's battery life. The AI system 114 may gather (extract) more details about this issue from the user (e.g., using prompts 211 and responses 221) during the session 208 (act 218), including specific customer comments and frequency of reports. The AI system may store a new set of information 219, corresponding to the new information, in an insight archive 130 (act 220), which may be referenced in future analyses.

In the example scenario, the insight archive 130 may include an insight identity of “Battery Life Issues—March 2024” and relevant aliases of “Battery Problems—Q1 2024” and “Power Issues—Early 2024”. The insight archive 130 may also include a description that summarizes the recurring battery life issue, findings that highlight the key insights associated with the issue, a narrative explaining the implications of the insight, and metrics providing quantitative data associated with the recurring battery life issue.

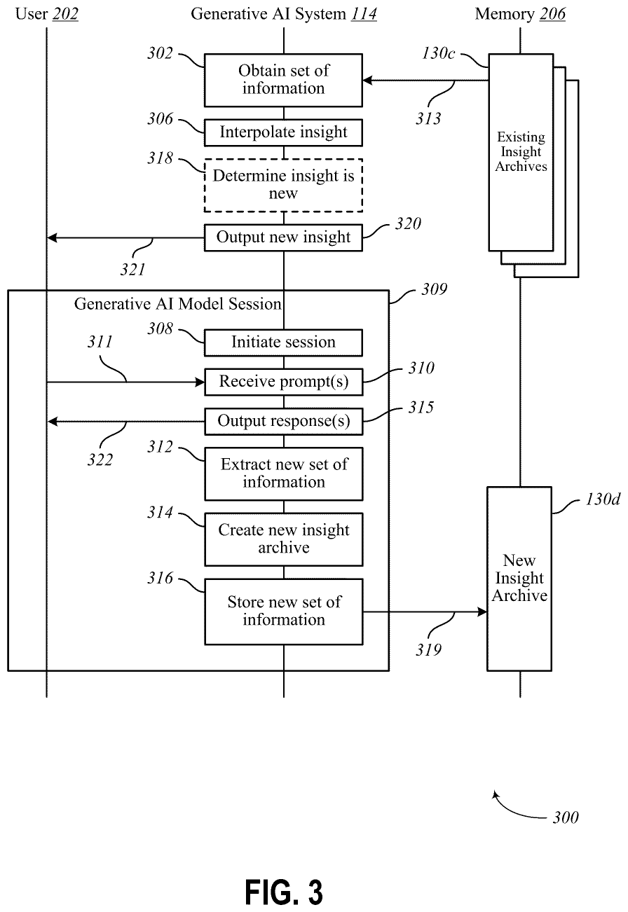

FIG. 3 illustrates an example process 300 in which a new insight is determined, which triggers a generative AI model session to be conducted to extract information about the new insight. A new insight archive is created to store the extracted insight information. This may provide information about a new insight to be obtained and stored even when the insight is determined outside a generative AI model session. This may enhance the information stored about the new insight.

In process 300, the generative AI system 114 obtains a set of information from one or more insight archives, analyzes the set of information to determine if a new insight can be interpolated and if so, initiates a generative AI model session to extract more information about the insight.

At act 302, the generative AI system 114 obtains a set of information 313 from a plurality of insight archives 130c. In some embodiments, the plurality of insight archives 130c are associated with a respective plurality of insights. In some embodiments, the plurality of insight archives 130c include containers holding information about the plurality of insights. In some embodiments, the plurality of insight archives 130c include documents and data associated with the plurality of insights. In some embodiments, the documents and data are associated with prior sessions associated with a generative AI model. The operations of act 302 may be performed in accordance with examples as disclosed herein. In some examples, aspects of the operations of act 302 may be performed by an insight archive manager 117 as described with reference to FIG. 1.

At act 306, the generative AI system 114 interpolates a new insight 321. The new insight 321 is interpolated based on the set of information 313 obtained from the plurality of insight archives 130c at act 302. In some embodiments, the new insight 321 is not included in the plurality of insights. The operations of act 306 may be performed in accordance with examples as disclosed herein. In some examples, aspects of the operations of act 306 may be performed by an insight interpolator 120 as described with reference to FIG. 1.

At optional act 318, the generative AI system 114 determines that the insight 321 is new. In some embodiments, the determination is made based on the interpolation performed by the generative AI system 114 at act 306. In some embodiments, determining that the insight 321 is new includes determining that the plurality of insights does not include the insight 321. The operations of act 318 may be performed in accordance with examples as disclosed herein. In some examples, aspects of the operations of act 318 may be performed by an insight interpolator 120 as described with reference to FIG. 1.

At act 320, the generative AI system 114 outputs the new insight 321 to the user 202. In some embodiments, the new insight 321 is provided not as an output of a generative AI model. In some embodiments, the new insight 321 is provided as an output of a generative AI model. The operations of act 320 may be performed in accordance with examples as disclosed herein. In some examples, aspects of the operations of act 320 may be performed by a user interface manager 116 as described with reference to FIG. 1.

In some embodiments, acts 302, 306, and/or 318 are repeated until a new insight 321 is able to be interpolated. For example, if a new insight cannot be interpolated at act 306 based on the set of information 313 (or the interpolated insight is determined to not be a new insight at act 318), the generative AI system 114 may repeat act 302 to obtain a new set of information and perform act 306 (and possibly 318) on the new set of information. This may continue until a new insight is interpolated at act 306 (or the interpolated insight is determined to be a new insight at act 318). Then the process may continue as discussed. In some examples, each time act 302 is performed, the new set of information may be obtained from a different insight archive 130c.

At act 308, the generative AI system 114 initiates a session 309 associated with a generative AI model. The session 309 is initiated by the generative AI system 114 based on interpolating the new insight at act 306. In some embodiments, act 320 is performed before the session 309 is initiated. In some embodiments, act 320 is performed after the session 309 is initiated, as part of the session. The session may be initiated by the generative AI system 114 on its own or in response to receiving a session request, e.g., from the user 202. The operations of act 308 may be performed in accordance with examples as disclosed herein. In some examples, aspects of the operations of act 308 may be performed by a generative AI model 128 as described with reference to FIG. 1.

At act 310, the generative AI system 114 receives one or more prompts 311 from the user 202 during the session 309. In some embodiments, the one or more prompts 311 are provided as inputs to the generative AI model. The act 310 and the one or more prompts 311 may be similar to the act 210 and prompt 211 of process 200. The operations of act 310 may be performed in accordance with examples as disclosed herein. In some examples, aspects of the operations of act 310 may be performed by a user interface manager 116 as described with reference to FIG. 1.

At act 315, the generative AI system 114 outputs one or more responses 322 to the user 202 based on the one or more prompts 311 received at act 310. Each outputted response 322 may be in response to a respective received prompt 311. For example, to generate each response 322, a corresponding prompt 311 may be processed through the generative AI model associated with the session 309. The act 315 and the one or more responses 322 may be similar to the act 234 and response 221 of process 200. The operations of act 315 may be performed in accordance with examples as disclosed herein. In some examples, aspects of the operations of act 315 may be performed by a user interface manager 116 as described with reference to FIG. 1.

At act 312, the generative AI system 114 extracts a new set of information 319. In some embodiments, the new set of information 319 is extracted based on the one or more prompts 311 received at act 310, the one or more corresponding responses output at act 315, and/or the new insight interpolated at act 306. In some embodiments, the new set of information 319 includes the new insight and information associated therewith. The operations of act 312 may be performed in accordance with examples as disclosed herein. In some examples, aspects of the operations of act 312 may be performed by an information extractor 118 as described with reference to FIG. 1.

At act 314, the generative AI system 114 creates a new insight archive 130d. In some embodiments, the new insight archive 130d is not included in the plurality of insight archives 130c. The operations of act 314 may be performed in accordance with examples as disclosed herein. In some examples, aspects of the operations of act 314 may be performed by an insight archive manager 117 as described with reference to FIG. 1.

At act 316, after the new insight archive 130d has been created, the generative AI system 114 stores the new set of information 319 in the new insight archive 130d. In some embodiments, the new insight archive 130d includes a container in which the new set of information 319 is stored. The operations of act 316 may be performed in accordance with examples as disclosed herein. In some examples, aspects of the operations of act 316 may be performed by an insight archive manager 117 as described with reference to FIG. 1.

Although acts 312, 314, and 316 are shown as being performed in conjunction with the generative AI model session 309, that is just one example. In other examples, one or more of acts 312, 314, or 316 may use information from session 309 but may be performed after session 309 has ended.

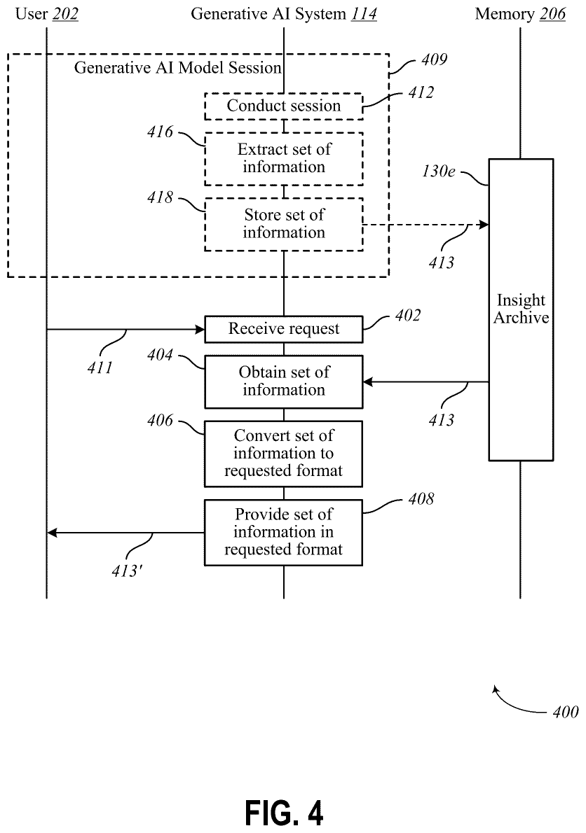

FIG. 4 illustrates an example process 400 in which insight information which was extracted from a prior generative AI model session, is converted to a requested format and output to the user. This may provide less overhead, more streamlined workflows, dynamic content presentation, and support for collaboration. It may provide insight adaptation for various audiences or purposes with minimal delay.

In process 400, the generative AI system 114 obtains a set of information from an insight archive after receiving a request from a user, converts the set of information to a requested format, and provides the set of information to the user in the requested format. In some embodiments, the generative AI system 114 performs a prior generative AI model session to extract and save the set of information before the set of information is obtained and converted.

At act 402, the generative AI system 114 receives a request 411 from the user 202, to provide a set of information 413 in a requested format. In some embodiments, the requested format is associated with one or more of: presentation slides, reading documents, or spreadsheets. In some examples, the requested format may be, e.g., one or more of; presentation slides (e.g., PowerPoint® slides), reading documents (e.g., Word® documents), or spreadsheets (e.g., Excel® spreadsheets). Other formats may also be used. In some embodiments, the request 411 may include an indication of the requested format. The operations of act 402 may be performed in accordance with examples as disclosed herein. In some examples, aspects of the operations of act 402 may be performed by a user interface manager 116 as described with reference to FIG. 1.

At act 404, the generative AI system 114 obtains the set of information 413 from an insight archive 130e. The set of information 413 is obtained by the generative AI system 114 in response to receiving the request 411 at act 402. The set of information 413 may be in a format different than the requested format. In some embodiments, the set of information 413 has been previously extracted from a prior session associated with a generative AI model and stored in the insight archive 130e. In some embodiments, the set of information is an example of the set of information 132 discussed with reference to FIG. 1. The operations of act 404 may be performed in accordance with examples as disclosed herein. In some examples, aspects of the operations of act 404 may be performed by an insight archive manager 117 as described with reference to FIG. 1.

At act 406, the generative AI system 114 converts the set of information 413 into the requested format. In some examples, the set of information 413 may be converted, e.g., into one or more of; presentation slides (e.g., PowerPoint® slides), reading documents (e.g., Word® documents), or spreadsheets (e.g., Excel® spreadsheets), based on the requested format. Other formats may also be used. The operations of act 406 may be performed in accordance with examples as disclosed herein. In some examples, aspects of the operations of act 406 may be performed by a format converter 122 as described with reference to FIG. 1.

At act 408, the generative AI system 114 provides the set of information 413′ to the user 202 in the requested format. The operations of act 408 may be performed in accordance with examples as disclosed herein. In some examples, aspects of the operations of act 408 may be performed by a user interface manager 116 as described with reference to FIG. 1.

In some embodiments, one or more of acts 402, 404, 406, or 408 are performed in a session of a generative AI model. For example, the request 411 may be provided as an input to a generative AI model (e.g., in a prompt) and the set of information 413′ may be provided as an output from the generative AI model (e.g., in response to the prompt).

In some embodiments, the generative AI system 114 also conducts the prior session (session 409), performing acts 412, 416, and 416. In some embodiments, the prior session 409 is conducted prior to obtaining the set of information performed at act 404.

At act 412, the generative AI system 114 conducts the session 409 associated with the generative AI model. The session 409 may be initiated by the user 202 or any other entity. During the session, the generative AI system 114 receives prompts from the user 202 and provides associated responses to the user based on processing the prompts through the generative AI model associated with the session 409, as discussed herein. The operations of act 412 may be performed in accordance with examples as disclosed herein. In some examples, aspects of the operations of act 226 may be performed by a user interface manager 116 as described with reference to FIG. 1.

At act 416, the generative AI system 114 extracts the set of information 413 from the session 409, which corresponds to the set of information 413. In some embodiments, the set of information 413 is extracted during the session 409. In some embodiments, the set of information 413 may be extracted based on a prompt received by the generative AI system 114. The operations of act 416 may be performed in accordance with examples as disclosed herein. In some examples, aspects of the operations of act 416 may be performed by an information extractor 118 as described with reference to FIG. 1.

At act 418, the generative AI system 114 stores the extracted set of information 413 in the insight archive 130e. In some embodiments, the generative AI system 114 first creates the insight archive 130e before storing the set of information 413. In some embodiments, the set of information 413 is stored in the insight archive 130e before the set of information 413 is obtained from the insight archive 130e at act 404. The operations of act 418 may be performed in accordance with examples as disclosed herein. In some examples, aspects of the operations of act 418 may be performed by an insight archive manager 117 as described with reference to FIG. 1.

Although acts 416 and 418 are shown as being performed in conjunction with the generative AI model session 409, that is just one example. In other examples, one or more of acts 416 and 418 may use information from session 409 but may be performed after session 409 has ended.

FIG. 5 illustrates an example computer system 500 that supports generative AI insight archives in accordance with one or more embodiments. The computer system 500 may include certain components therein. One or more computer systems 500 may be used to implement the various devices, components, and systems described herein.

The computer system 500 includes a processor 501. The processor 501 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) may be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

The computer system 500 may include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The computer system 500 may include one or more input devices 511 and one or more output devices 513. Some examples of input devices 511 include a keyboard, mouse, microphone, remote control device, button, joystick, trackball, touchpad, and light pen. Some examples of output devices 513 include a speaker and a printer. One specific type of output device that may be included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. The computer system 500 may also include a display controller 517 for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

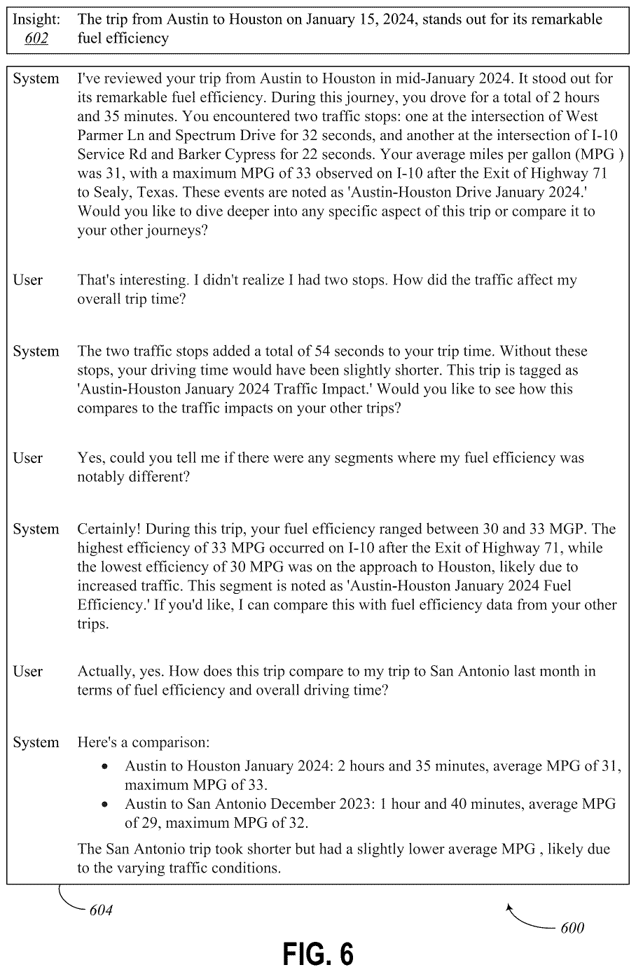

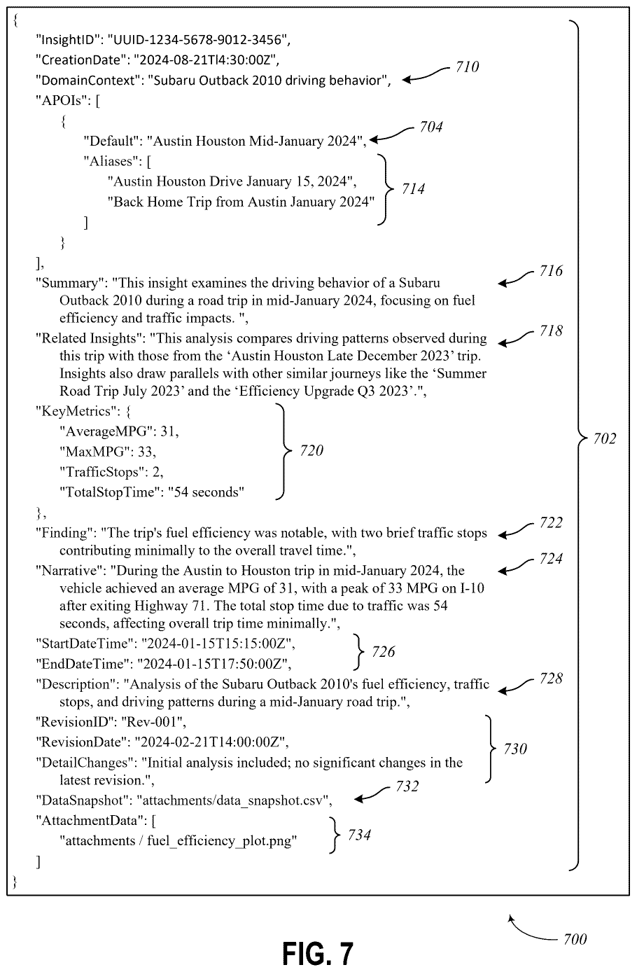

FIG. 6 shows an example scenario 600 that supports generative AI insight archives in accordance with one or more embodiments. The example scenario 600 may be used in conjunction with one or more of the embodiments discussed herein, e.g., with process 200 or process 300. In conjunction with FIG. 6, FIG. 7 shows an example of a portion of a new insight archive 700. The new insight archive 700 may be an example of the insight archives discussed herein (e.g., insight archives 130 discussed with respect to FIGS. 1, 2, and 3). In the scenario 600, the AI system analyzes a user's driving patterns and identifies a trip with unusually high fuel efficiency. The analysis may be performed using a set of information, e.g., driving pattern information, obtained from one or more existing insight archives (e.g., in act 212 of process 200 or act 302 of process 300). The analysis or the obtaining of the set of information or both may be performed outside of an AI model session (e.g., in act 302 of process 300) or during an AI model session (e.g., in act 212 of process 200), e.g., in response to a prompt received by a user (e.g., in act 210 of process 200).

Based on the analysis, the AI system interpolates a new insight 602: “The trip from Austin to Houston on Jan. 15, 2024, stands out for its remarkable fuel efficiency.” (e.g., in act 216 of process 200 or act 306 of process 300). The AI system outputs the new insight 602 to the user (e.g., in act 234 of process 200 or act 320 of process 300) with suggested names to use as the insight identity of the new insight. For example, the AI system may suggest three names to the user: 1) “Austin Houston Drive January 2024,” 2) “Austin Houston Mid-January 2024,” and 3) “Back Home Trip from Austin January 2024.” The user selects one of the names: “Austin Houston Mid-January 2024,” which becomes the insight identity for the new insight.

If a generative AI model session 604 has not yet been initiated, the AI system may initiate the session (e.g., in act 308 of process 300) on its own or in response to receiving a session request, e.g., from the user. As shown, during the session 604, additional information is teased out related to the new insight 602 based on prompts from the user and corresponding responses from the AI system based on those prompts. Based on the new insight 602 and the additional information from the session 604, a new set of information 702 is extracted (e.g., in act 218 of process 200 or act 312 of process 300).

The AI system creates the new insight archive 700 (e.g., in act 236 of process 200 or act 314 of process 300), using the insight identity 704 as the filename. The AI system stores the new set of information 702 in the new insight archive 700 (e.g., in act 220 of process 200 or act 316 of process 300).

FIG. 7 shows an example of the new set of information 702 stored in the insight archive 700. The new set of information 702 includes:
a domain context 710 (“Subaru Outback 2010 driving behavior”);
the insight identity 704 (“Austin Houston Mid-January 2024”);
aliases 714 (“Austin Houston Mid-January 2024,” and “Back Home Trip from Austin January 2024”);
a summary 716 (“This insight examines the driving behavior of a Subaru Outback 2010 during a road trip in mid-January 2024, focusing on fuel efficiency and traffic impacts”);
related insights 718 (“This analysis compares driving patterns observed during this trip with those from the ‘Austin Houston Late December 2023’ trip. Insights also draw parallels with other similar journeys like the ‘Summer Road Trip July 2023’ and the ‘Efficiency Upgrade Q3 2023’”);
metrics 720 (Average MPG, Max MPG, Traffic Stops, Total Stop Time);
findings related to the insight 722 (“The trip's fuel efficiency was notable, with two brief traffic stops contributing minimally to the overall travel time”);
a narrative 724 (“During the Austin to Houston trip in mid-January 2024, the vehicle achieved an average MPG of 31, with a peak of 33 MPG on I-10 after exiting Highway 71. The total stop time due to traffic was 54 seconds, affecting overall trip time minimally”),
time stamps 726 (Start Date/Time, End Date/Time);
a description of the insight 728 (“Analysis of the Subaru Outback 2010's fuel efficiency, traffic stops, and driving patterns during a mid-January road trip”); and
revision information 730, including revision ID, revision date, and revisions made.

The AI system also stores other information in the insight archive 700, such as a data snapshot (data that is collected and attached and may include GPS logs, fuel efficiency metrics, speed variations, and time spent at rest stops during the trip) and other attachments (such as visualizations). As shown, the set of information 702 also includes references to the locations of data snapshot 732 and the other attached information 734.

The initial insight archive or the new insight archive 700 may be used for further analysis, including determining new or evolved insights via interpolation (e.g., in a subsequent AI model session).

For example, as discussed above, the insight archive captured a Subaru Outback's fuel efficiency during a winter trip. Suppose that later, data about tire performance during summer may be obtained. The summer tire performance data may not directly correspond to winter fuel efficiency, but it is related in the broader domain of vehicle performance. As a result, using interpolation, the AI system may synthesize the summer tire performance data into the insight archive (e.g., by adding a data snapshot), to highlight how seasonal differences may affect efficiency, enabling richer insights.

Or suppose that the initial insight archive focused on GPS logs and speed variations associated with the winter trip when determining the fuel efficiency. And suppose that subsequent data is be obtained that includes weather conditions and driver behavior logs. Using interpolation, this subsequent data may be integrated into the analysis to provide additional dimensions for showing correlations (e.g., reduced speed during icy conditions, etc.). The AI system may perform updates to the insight archive (e.g., to a data snapshot, key metrics, or narrative section of the set of information) based on the additional dimensions.

Or suppose that new fuel efficiency data for the Subaru Outback associated with other regions becomes available. Using interpolation, the new fuel efficiency data may be integrated into the insight archive to allow comparison across regions, showing whether observed patterns are local anomalies or general trends. This may show how the insight evolves. The AI system may perform updates to the insight archive (e.g., to a Revision ID and/or a Detail Changes section) to document the evolution of the insight.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
receiving a prompt by a generative artificial intelligence (AI) model during a session associated with the generative AI model;
obtaining, by the generative AI model in response to receiving the prompt a first set of information from a first insight archive, the first insight archive including data and a document associated with a first insight, the first set of information from a prior session associated with the generative AI model and stored in the first insight archive;
generating, by the generative AI model, a second insight from at least the first set of information obtained from the first insight archive;
providing as an output, by the generative AI model, the second insight as a response to the prompt;
extracting, by the generative AI model, a second set of information used by the generative AI model to generate the second insight; and
storing, by the generative AI model, the second set of information in a second insight archive, the second set of information including cross-reference information to the first insight archive.

2-3. (canceled)

4. The method of claim 1, wherein the second set of information includes the second insight and information associated therewith.

5. The method of claim 1, wherein the response to the prompt includes the second insight.

6. The method of claim 1, wherein the prompt is one of a plurality of prompts received by the generative AI model during the session and the response is one of a plurality of responses output by the generative AI model during the session, and wherein the second set of information includes the plurality of prompts and the plurality of responses.

7. The method of claim 1, further comprising:
storing data associated with the second set of information in a cache;
obtaining the data from the cache in response to a second prompt; and
providing as an output a second response to the second prompt, the second response including the data obtained from the cache.

8. (canceled)

9. A method, comprising:
receiving a first prompt by a generative artificial intelligence (AI) model during a first session associated with the generative AI model;
extracting, by the generative AI model in response to receiving the first prompt, a first set of information used by the generative AI model to generate a first insight;
storing, by the generative AI model, the first set of information in a first insight archive associated with the first insight;
receiving a second prompt by the generative AI model during a second session associated with the generative AI model;
obtaining, by the generative AI model in response to receiving the second prompt, the first set of information from the first insight archive;
generating, by the generative AI model, a second insight from at least in part the first set of information obtained from the first insight archive;
providing as an output, by the generative AI model, a response to the second prompt;
extracting, by the generative AI model, a second set of information used by the generative AI model to generate the second insight; and
storing, by the generative AI model, the second set of information in a second insight archive, the second set of information including cross-reference information to the first insight archive.

10-12. (canceled)

13. The method of claim 9, wherein the response to the second prompt includes the second insight.

14. A computer system comprising:
a processor;
a memory including a generative artificial intelligence (AI) model and instructions causing the processor to perform the instructions, wherein the instructions include:
receive during a session a prompt by a generative AI model;
obtain, by the generative AI model, a first set of information from a plurality of insight archives in response to the prompt, each of the plurality of insight archives including an insight and data used by the generative AI model to generate the insight;
generate, by the generative AI model, a first insight from at least the first set of information obtained from the plurality of insight archives, wherein the first insight is not included in the plurality of insight archives;
provide the first insight as an output, by the generative AI model;
extract, by the generative AI model, a second set of information used by the generative AI model to generate the first insight, the second set of information including the first insight and cross-reference information to the plurality of insight archives;
create, by the generative AI model, a first insight archive; and
store, by the generative AI model, the second set of information in the first insight archive.

15. The non-transitory processor-readable storage medium of claim 14, further comprising:
determining that the plurality of insights does not include the first insight.

16. (canceled)

17. The non-transitory processor-readable storage medium of claim 14, wherein the second set of information includes the first insight and information associated therewith.

18. The non-transitory processor-readable storage medium of claim 14, wherein the plurality of insight archives include documents and data associated with the plurality of insights.

19. The non-transitory processor-readable storage medium of claim 18, wherein the documents and data are associated with prior sessions associated with the generative AI model.

20. A method, comprising:
receiving, by a computer, a request to provide a first set of information in a first format;
obtaining, by the computer in response to receiving the request, the first set of information from a first insight archive, the first set of information having been extracted from a prior session with a generative artificial intelligence (AI) model and stored in the first insight archive, the first set of information including cross-reference information to a second set of information stored within a second insight archive that was used by the generative AI model to generate an insight stored in the second insight archive;
converting, by the generative AI model, the first set of information into the first format; and
providing as an output, by the generative AI model, the first set of information in the first format.

21. The method of claim 20, wherein the request includes an indication of the first format.

22. The method of claim 20, wherein the first format is associated with one or more of a presentation slides, a documents, or a spreadsheets.

23. The method of claim 20, wherein the request is received in a second session associated with the generative AI model.

24. (canceled)

25. The method of claim 1, wherein storing the second set of information in the second insight archive includes embedding the second insight in metadata of the second insight archive.

26. The method of claim 1, wherein the first insight archive includes a plurality of revisions of the first insight, wherein each revision of the first insight includes one or more of a revision ID, a timestamp indicating when the revision was made, or revision information associated with the revision.

27. The method of claim 1, wherein storing the second set of information in the second insight archive includes storing a signature file.

28. The method of claim 27, wherein the signature file includes one or more of a hash value, an identifier of an algorithm used to generate the signature file, and/or a timestamp associated with the signature file.

29. The method of claim 9, wherein storing the first set of information in a first insight archive associated with the first insight includes embedding the first insight in metadata of the first insight archive, wherein obtaining, by the computer in response to receiving the second prompt, the first set of information from the first insight archive includes accessing, by the computer, the metadata of the first insight archive and determining whether the first insight archive is responsive to the second prompt based on metadata.

30. The method of claim 20, wherein the first insight is embedded in metadata of the first insight archive.

31. The method of claim 30, wherein providing as the output the first set of information in the first format includes outputting the metadata.

32. The method of claim 20, wherein the first insight archive includes a plurality of revisions of the first insight, wherein each revision of the first insight includes one or more of a revision ID, a timestamp indicating when the revision was made, or revision information associated with the revision.
